(19) United States
(12) Patent Application Publication
(10) Pub. No.: US 2025/0180896 A1
(43) Pub. Date: Jun. 5, 2025

(54) IMAGE CAPTURING DEVICE

(71) Applicant: TDK TAIWAN CORP., Taoyuan City (TW)

(72) Inventors: Mao-Kuo HSU, Taoyuan City (TW); Chao-Chang HU, Taoyuan City (TW); Yi-Ho CHEN, Taoyuan City (TW); Yu-Chi KUO, Taoyuan City (TW); Sz-Hsuan LIU, Taoyuan City (TW)

(21) Appl. No.: 18/964,193

(22) Filed: Nov. 29, 2024

Related U.S. Application Data
(60) Provisional application No. 63/604,459, filed on Nov. 30, 2023.

(51) Int. Cl. G02B 27/00; G03B 17/55

(52) U.S. Cl. CPC G02B 27/0006; G03B 17/55

(57) ABSTRACT

An image capturing device is provided. The image capturing device includes a device housing, a lens, a vibration unit and a temperature modulation unit. The lens is disposed within the device housing. The vibration unit is configured to vibrate the lens. The temperature modulation unit is configured to modulate the temperature of the lens.

### CROSS REFERENCE TO RELATED APPLICATIONS

This application claims the benefit of U.S. Provisional Application No. 63/604,459, filed Nov. 30, 2023, the entirety of which is incorporated by reference herein.

### BACKGROUND OF THE INVENTION

### Field of the Invention

The present invention relates to an image capturing device, and, in particular, to an image capturing device with temperature modulation functions.

### Description of the Related Art

Conventional image capturing devices (dash cameras, for example) typically include components like protective lenses, device housings, imaging lenses, and image capturing modules (e.g., photosensitive coupling elements). The protective lens is generally in contact with the outside air. Depending on external temperature and humidity conditions, water droplets or frost may form on the protective lens, and this has an impact on the performance of the image capturing device, potentially compromising road safety.

### BRIEF SUMMARY OF THE INVENTION

An embodiment of the invention provides an image capturing device. The image capturing device includes a device housing, a lens, a vibration unit, and a temperature modulation unit. The lens is disposed within the device housing. The vibration unit is configured to vibrate the lens. The temperature modulation unit is configured to modulate the temperature of the lens.

The image capturing device of the embodiment of the invention utilizes a vibration unit to vibrate the lens and utilizes a temperature modulation unit to modulate the lens's temperature. Thus, when water droplets, fog, or frost form on the lens surface, the temperature modulation unit can remove the fog and frost, while the vibration unit shakes off water droplets. Compared to the conventional art, the image capturing device of the embodiments of the invention can be used in various inclement weather conditions, and driving safety is improved.

### BRIEF DESCRIPTION OF THE DRAWINGS

The present invention can be more fully understood by reading the subsequent detailed description and examples with references made to the accompanying drawings, wherein:

FIG. 1A is a perspective view of an image capturing device of a first embodiment of the invention;

FIG. 1B is an exploded view of the image capturing device of the first embodiment of the invention;

FIG. 1C is a cross-sectional view of a portion of the image capturing device of the first embodiment of the invention;

FIG. 2 is a cross-sectional view of a portion of an image capturing device of a second embodiment of the invention;

FIG. 3 is a cross-sectional view of a portion of an image capturing device of a third embodiment of the invention;

FIG. 4 is a cross-sectional view of a portion of an image capturing device of a fourth embodiment of the invention;

FIG. 5 is a cross-sectional view of a portion of an image capturing device of a fifth embodiment of the invention;

FIG. 6 is a cross-sectional view of a portion of an image capturing device of a sixth embodiment of the invention;

FIG. 7 is a cross-sectional view of a portion of an image capturing device of a seventh embodiment of the invention; and

FIG. 8 is a cross-sectional view of a portion of an image capturing device of an eighth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

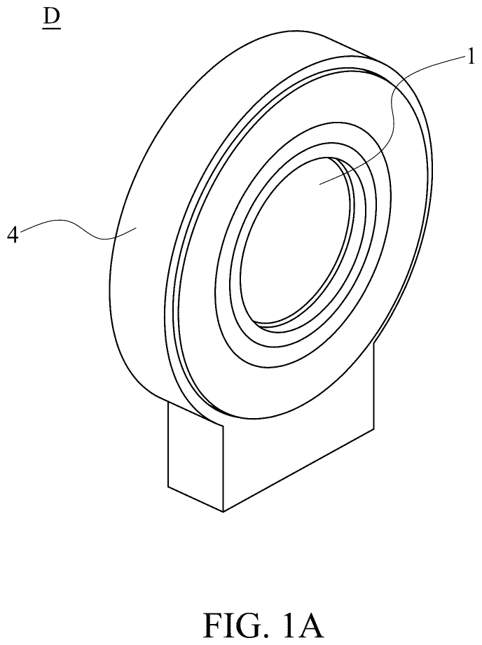

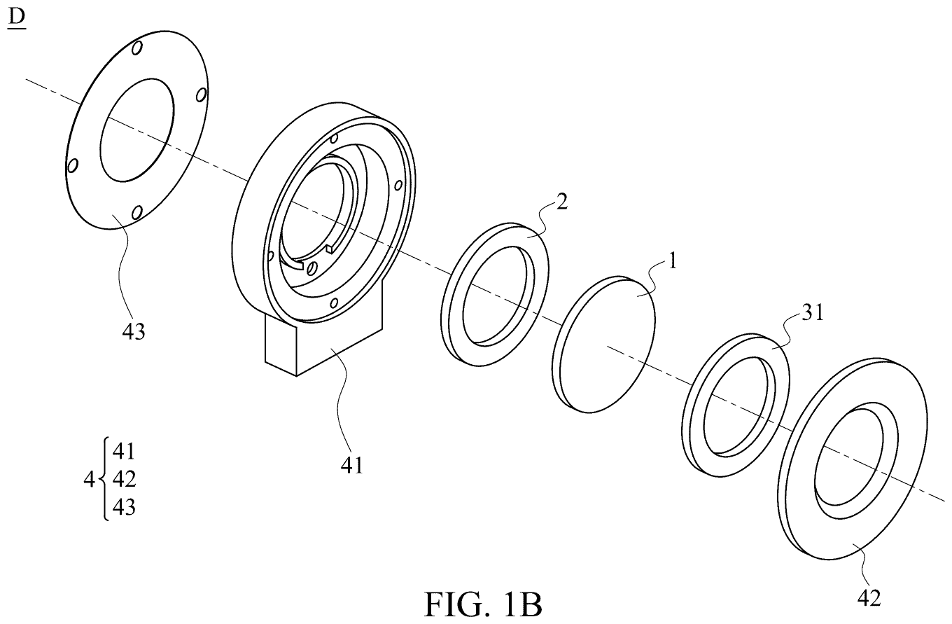

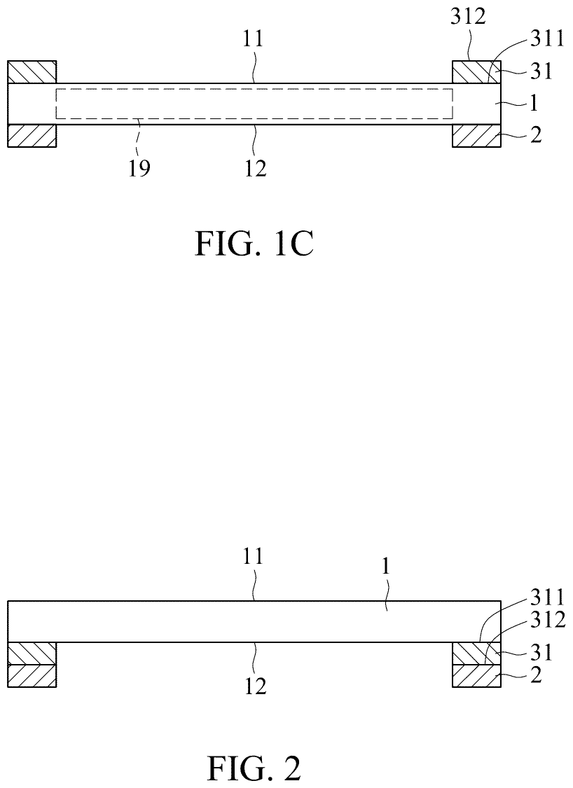

FIG. 1A is a perspective view of an image capturing device of a first embodiment of the invention. FIG. 1B is an exploded view of the image capturing device of the first embodiment of the invention. FIG. 1C is a cross-sectional view of a portion of the image capturing device of the first embodiment of the invention. With reference to FIGS. 1A, 1B, and 1C, the image capturing device D of the embodiments of the invention comprises a device housing 4, a lens 1, a vibration unit 2, and a temperature modulation unit 31. The lens 1 is disposed within the device housing 4. The vibration unit 2 is configured to vibrate the lens 1. The temperature modulation unit 31 is configured to modulate the temperature of the lens 1.

With reference to FIG. 1B, in one embodiment, the device housing 4 comprises a housing body 41, an outer cover 42, and a back cover 43. The disclosure is not meant to restrict the invention.

With reference to FIG. 1C, in one embodiment, the lens 1 comprises a first surface 11 and a second surface 12. The first surface 11 is opposite the second surface 12. The vibration unit 2 is directly or indirectly connected to the second surface 12 to vibrate the lens 1.

With reference to FIG. 1C, in one embodiment, the temperature modulation unit 31 is a thermoelectric cooling unit. The temperature modulation unit 31 includes a hot end 311 and a cold end 312. The hot end 311 is thermally connected to the lens 1 to modulate the temperature of the lens 1. Specifically, when frost or fog forms on the surface of the lens 1, the temperature modulation unit 31 heats the lens 1 to perform a defrosting or defogging function.

With reference to FIG. 1C, in one embodiment, the vibration unit 2 is directly connected to the second surface 12. The temperature modulation unit 31 is directly connected to the first surface 11. Both the vibration unit 2 and the temperature modulation unit 31 are located outside an imaging area 19 of the lens 1. The vibration unit 2 is configured to remove water droplets through vibration.

In one embodiment, the lens 1 is a protective lens, wherein the first surface 11 is exposed to the external environment, and the second surface 12 faces the interior of the image capturing device D. The disclosure is not meant to restrict the invention. For example, in another embodiment, the lens 1 may also serve as an imaging lens (such as a convex lens or a concave lens).

With reference to FIG. 1C, in one embodiment, the vibration unit 2 corresponds to the temperature modulation unit 31, and at least a portion of the lens 1 is sandwiched between the vibration unit 2 and the temperature modulation unit 31.

FIG. 2 is a cross-sectional view of a portion of an image capturing device of a second embodiment of the invention. With reference to FIG. 2, in this embodiment, the temperature modulation unit 31 is directly connected to the second surface 12. The vibration unit 2 is stacked on the temperature modulation unit 31. The vibrations generated by the vibration unit 2 are transmitted to the lens 1 through the temperature modulation unit 31.

With reference to FIG. 2, in this embodiment, the hot end 311 of the temperature modulation unit 31 is thermally connected to the lens 1 to modulate the temperature of the lens 1. The cold end 312 of the temperature modulation unit 31 is connected to the vibration unit 2 to modulate the temperature of the vibration unit 2. Specifically, when frost or fog forms on the surface of the lens 1, the temperature modulation unit 31 heats the lens 1 to perform a defrosting or defogging function. Additionally, the temperature modulation unit 31 cools the vibration unit 2, preventing the vibration unit 2 from overheating during prolonged operation and extending the life span of the vibration unit 2.

FIG. 3 is a cross-sectional view of a portion of an image capturing device of a third embodiment of the invention. With reference to FIG. 3, in this embodiment, the vibration unit 2 is directly connected to the second surface 12. The temperature modulation unit 31 is also directly connected to the second surface 12. Both the vibration unit 2 and the temperature modulation unit 31 are located outside an imaging area 19 of the lens 1. In this embodiment, the temperature modulation unit 31 is arranged to surround the vibration unit 2. The disclosure is not meant to restrict the invention. For example, in another embodiment, the vibration unit 2 may surround the temperature modulation unit 31.

With reference to FIG. 3, in this embodiment, the image capturing device further comprises an image capturing module 6 (e.g., a photosensitive coupling element) and a heat conductive module 51. The hot end 311 of the temperature modulation unit 31 is thermally connected to the lens 1 to modulate the temperature of the lens 1. The heat conductive module 51 thermally connects the cold end 312 of the temperature modulation unit 31 to the image capturing module 6. Specifically, when frost or fog forms on the surface of the lens 1, the temperature modulation unit 31 heats the lens 1 to perform a defrosting or defogging function. Additionally, the temperature modulation unit 31 cools the image capturing module 6, preventing the image capturing module 6 from overheating during prolonged operation and extending its life span. The disclosure is not meant to restrict the invention. For example, in another embodiment, the heat conductive module 51 may thermally connect the cold end 312 of the temperature modulation unit 31 to other heat sources (e.g., a chip) to provide cooling effects for the heat source.

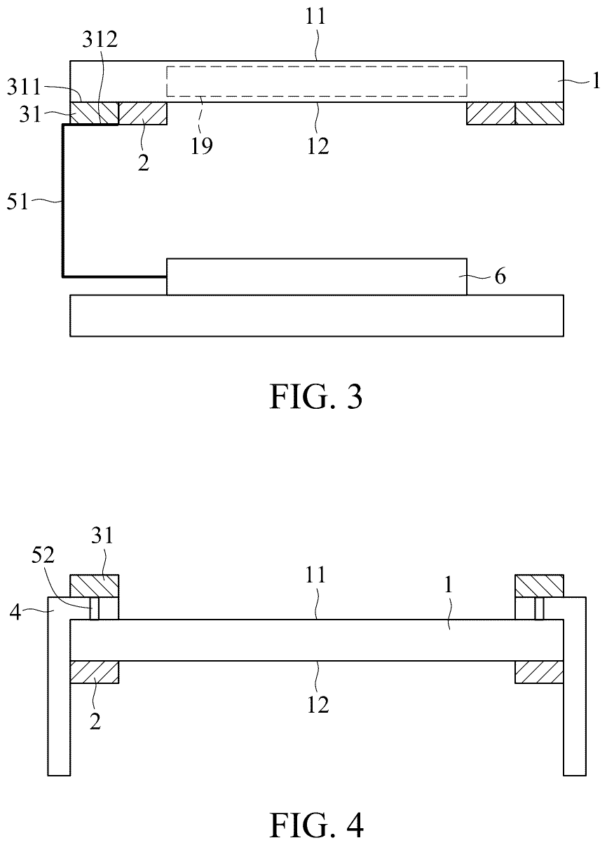

FIG. 4 is a cross-sectional view of a portion of an image capturing device of a fourth embodiment of the invention. With reference to FIG. 4, in this embodiment, the temperature modulation unit 31 is disposed on the device housing 4. The device housing 4 is directly or indirectly connected to at least a portion of the first surface 11. The heat generated by the temperature modulation unit 31 is transferred to the lens 1 through the device housing 4.

With reference to FIG. 4, in one embodiment, the image capturing device further includes a thermally conductive material 52. The thermally conductive material 52 is disposed on the device housing 4 and is directly connected to at least a portion of the first surface 11. The thermally conductive material 52 thermally connects the temperature modulation unit 31 to the lens 1. Thus, when frost or fog forms on the surface of the lens 1, the temperature modulation unit 31 heats the lens 1 to perform a defrosting or defogging function.

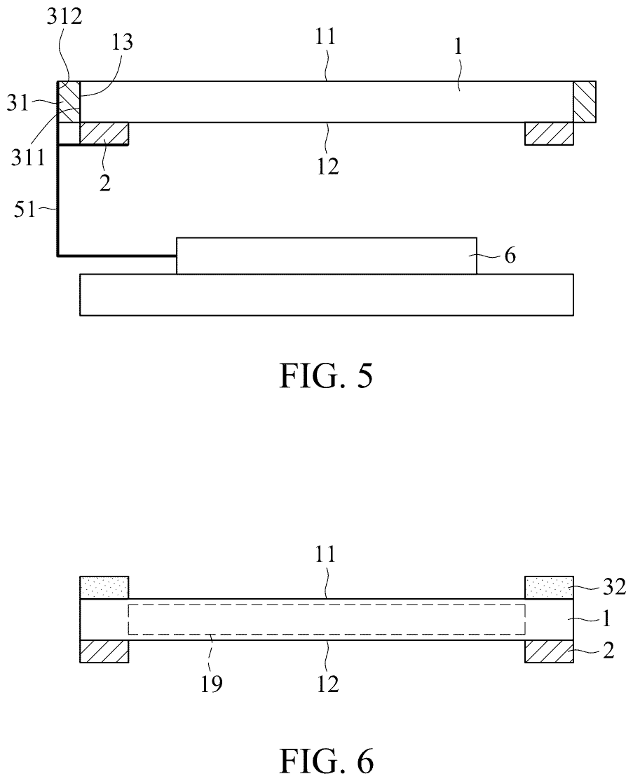

FIG. 5 is a cross-sectional view of a portion of an image capturing device of a fifth embodiment of the invention. With reference to FIG. 5, in this embodiment, the lens 1 further includes a side surface 13, and the hot end 311 of the temperature modulation unit 31 is directly connected to the side surface 13 to modulate the temperature of the lens 1. Therefore, when frost or fog forms on the surface of the lens 1, the temperature modulation unit 31 heats the lens 1 to perform a defrosting or defogging function. In this embodiment, the temperature modulation unit 31 can surround the edge of the lens 1. The disclosure is not meant to restrict the invention.

With reference to FIG. 5, in this embodiment, the image capturing device further comprises an image capturing module 6 (e.g., a photosensitive coupling element) and a heat conductive module 51. The hot end 311 of the temperature modulation unit 31 is thermally connected to the lens 1 to modulate the temperature of the lens 1. The heat conductive module 51 thermally connects the cold end 312 of the temperature modulation unit 31 to the image capturing module 6 and the vibration unit 2. Specifically, when frost or fog forms on the surface of the lens 1, the temperature modulation unit 31 heats the lens 1 to perform a defrosting or defogging function. Additionally, the temperature modulation unit 31 cools the image capturing module 6 and the vibration unit 2, preventing the image capturing module 6 and the vibration unit 2 from overheating during prolonged operation and extending its life span.

FIG. 6 is a cross-sectional view of a portion of an image capturing device of a sixth embodiment of the invention. With reference to FIG. 6, in this embodiment, the temperature modulation unit 32 is a heating wire unit. The temperature modulation unit 32 is disposed outside the imaging area 19 of the lens 1. The temperature modulation unit 32 is disposed on the first surface 11. The heating wire unit can provide thermal energy. Thus, when frost or fog forms on the surface of the lens 1, the temperature modulation unit 32 heats the lens 1 to perform a defrosting or defogging function.

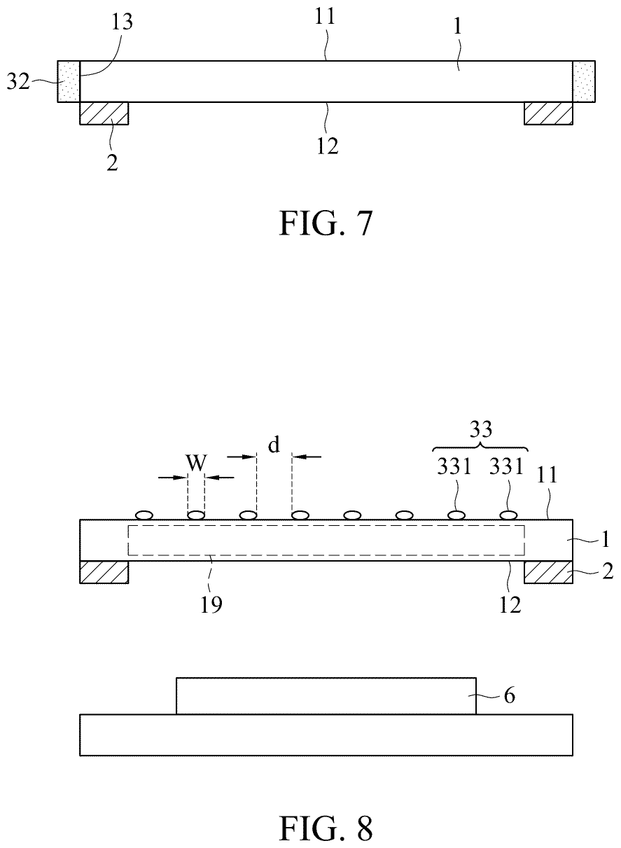

FIG. 7 is a cross-sectional view of a portion of an image capturing device of a seventh embodiment of the invention. With reference to FIG. 7, in this embodiment, the lens 1 further includes a side surface 13. The temperature modulation unit 32 is disposed on the side surface 13. Thus, when frost or fog forms on the surface of the lens 1, the temperature modulation unit 32 heats the lens 1 to perform a defrosting or defogging function.

FIG. 8 is a cross-sectional view of a portion of an image capturing device of an eighth embodiment of the invention. With reference to FIG. 8, in this embodiment, the temperature modulation unit 33 is a heating wire unit. The temperature modulation unit 33 is disposed within the imaging area 19 of the lens 1. The temperature modulation unit 33 is disposed on the first surface 11 of the lens 1. Thus, when frost or fog forms on the surface of the lens 1, the temperature modulation unit 33 heats the lens 1 to perform a defrosting or defogging function.

With reference to FIG. 8, in one embodiment, the temperature modulation unit 33 includes a plurality of heating wires 331, and each heating wire has a line width w less than 1.5 millimeters.

With reference to FIG. 8, in one embodiment, at least some of the heating wires 331 are arranged parallel to each other. There is a space d of more than 1.5 millimeters between each two adjacent heating wires 331. In one embodiment, the image capturing device further includes an image capturing module 6, and the field of view (FOV) of the image capturing device is wider than 60 degrees×60 degrees. Meaning that the observable angle in the horizontal direction is greater than 60 degrees, and the observable angle in the vertical direction is also greater than 60 degrees. With this design, the heating wires are not visible in the image captured by the image capturing device.

In the embodiments above, the vibration unit is a piezoelectric vibration unit. However, the disclosure is not meant to restrict the invention. The vibration unit may also take other forms.

The image capturing device of the embodiment of the invention utilizes a vibration unit to vibrate the lens and utilizes a temperature modulation unit to modulate the lens's temperature. Thus, when water droplets, fog, or frost form on the lens surface, the temperature modulation unit can remove the fog and frost, while the vibration unit shakes off water droplets. Compared to the conventional art, the image capturing device of the embodiments of the invention can be used in various inclement weather conditions, and driving safety is improved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An image capturing device, comprising:
a device housing;
a lens, disposed within the device housing;
a vibration unit, configured to vibrate the lens; and
a temperature modulation unit, configured to modulate the temperature of the lens.

2. The image capturing device as claimed in claim 1, wherein the lens comprises a first surface and a second surface, the second surface is opposite the first surface, and the vibration unit is directly or indirectly connected to the second surface to vibrate the lens.

3. The image capturing device as claimed in claim 2, wherein the temperature modulation unit is a thermoelectric cooling unit, the temperature modulation unit comprises a hot end and a cold end, and the hot end is thermally connected to the lens to modulate the temperature of the lens.

4. The image capturing device as claimed in claim 3, wherein the vibration unit is directly connected to the second surface, the temperature modulation unit is directly connected to the first surface, and both the vibration unit and the temperature modulation unit are located outside an imaging area of the lens.

5. The image capturing device as claimed in claim 4, wherein the vibration unit corresponds to the temperature modulation unit, and at least a portion of the lens is sandwiched between the vibration unit and the temperature modulation unit.

6. The image capturing device as claimed in claim 3, wherein the temperature modulation unit is directly connected to the second surface, the vibration unit is stacked on the temperature modulation unit, and the vibrations generated by the vibration unit are transmitted to the lens through the temperature modulation unit.

7. The image capturing device as claimed in claim 6, wherein the cold end of the temperature modulation unit is connected to the vibration unit to modulate the temperature of the vibration unit.

8. The image capturing device as claimed in claim 3, wherein the vibration unit and the temperature modulation unit are both directly connected to the second surface, and the vibration unit and the temperature modulation unit are both disposed outside the imaging area of the lens.

9. The image capturing device as claimed in claim 8, further comprising an image capturing module and a heat conductive module, wherein the heat conductive module thermally connects the cold end of the temperature modulation unit to the image capturing module.

10. The image capturing device as claimed in claim 3, wherein the temperature modulation unit is disposed on the device housing, the device housing is directly or indirectly connected to at least a portion of the first surface, and the heat generated by the temperature modulation unit is transmitted to the lens via the device housing.

11. The image capturing device as claimed in claim 10, further comprising a thermally conductive material, wherein the thermally conductive material is disposed in the device housing and is directly connected to at least a portion of the first surface, and the thermally conductive material thermally connects the temperature modulation unit to the lens.

12. The image capturing device as claimed in claim 3, further comprising an image capturing module and a heat conductive module, wherein the lens further comprises a side surface, the hot end of the temperature modulation unit is directly connected to the side surface to modulate the temperature of the lens, and the heat conductive module thermally connects the cold end of the temperature modulation unit to the vibration unit and the image capturing module.

13. The image capturing device as claimed in claim 2, wherein the temperature modulation unit is a heating wire unit and the temperature modulation unit is disposed outside the imaging area of the lens.

14. The image capturing device as claimed in claim 13, wherein the lens further comprises a side surface, and the temperature modulation unit is disposed on either the first surface or the side surface.

15. The image capturing device as claimed in claim 2, wherein the temperature modulation unit is a heating wire unit, and the temperature modulation unit is disposed within the imaging area of the lens.

16. The image capturing device as claimed in claim 15, wherein the temperature modulation unit is disposed on the first surface of the lens.

17. The image capturing device as claimed in claim 15, wherein the temperature modulation unit comprises a plurality of heating wires, and each heating wire has a line width of less than 1.5 mm.

18. The image capturing device as claimed in claim 16, wherein at least some of the heating wires are arranged in a parallel manner, and between each two adjacent heating wires there is a space of more than 1.5 mm.

19. The image capturing device as claimed in claim 16, further comprising an image capturing module, wherein the field of view (FOV) of the image capturing device is wider than 60 degrees×60 degrees.

20. The image capturing device as claimed in claim 1, wherein the vibration unit is a piezoelectric vibration unit.
